(19) United States
(12) Patent Application Publication
(10) Pub. No.: US 2011/0133609 A1
(43) Pub. Date: Jun. 9, 2011

(54) ELECTRIC MOTOR AND ELECTRIC DRIVE UNIT FOR MOTOR VEHICLES

(76) Inventor: Uwe Klippert, Rödental (DE)

(21) Appl. No.: 11/576,067

(22) PCT Filed: Sep. 23, 2005
(86) PCT No.: PCT/EP05/54781

§ 371 Date: May 15, 2009

(30) Foreign Application Priority Data
Sep. 29, 2004 (DE) 20 2004 015 271.1

(51) Int. Cl. H02K 13/10; H02K 11/00; H01R 39/38

(52) U.S. Cl. 310/68 R; 310/242; 310/245; 310/239

(57) ABSTRACT

The invention relates to an electric motor for motor vehicles, in particular a direct current low-power electric motor, comprising a housing (3) and a brush assembly holder (7) which holds at least two brush holders (21) with brushes (22) attached thereto, such that the brushes (22) are in biased contact with commutator (23), wherein the brushes (22) are pre-ground corresponding to commutator (23).

According to the invention, the brush assembly holder (7) is movably supported in relation to the commutator (23) and a limit stop (13) fixed relative to the housing is provided in order to position the brushes (22) accurately on the commutator. Consequently, further production tolerances, for example when pushing the plug-in electronic module into the housing of the electric motor, have no effect on the accuracy with which the brushes are positioned.

The invention further relates to an electric drive unit for motor vehicles, in particular for window lifts or designed as an electric actuator unit, comprising the electric motor referred to above.

### FIELD OF THE INVENTION

The present invention relates to an electric motor for electric drive units of motor vehicles, in particular a direct current low-power electric motor, for example a permanent-magnet direct current low-power electric motor. The invention further relates to an electric drive unit for motor vehicles.

### BACKGROUND OF THE INVENTION

With an electric motor of the type initially referred to, the current supply in the rotor winding takes place by way of brushes or carbons which provide a sliding contact with the rotating commutator and thus supply the coils with current. The beginnings and ends of the rotor coils are connected to the bars of the commutator (also called the collector). The commutator's bars are separate and distributed evenly around the electric motor's axis of rotation whereby diametrically opposed bars are joined in each case to the ends of the same turn of the rotor or to an assembly of connections switched in parallel. Two likewise diametrically opposed stationary brushes or carbons are connected to the bars of the commutator in a sliding contact. Commutator and brushes act as a mechanical switch or inverter in order to reverse the current direction appropriately through the rotor windings.

Noises, which are frequently perceived as annoying, occur when the brushes or carbons slide or rub on the commutator bars.

The following two solutions are known in particular from the prior art for reducing noise development: according to a first approach, such as is disclosed for example in the German utility model DE 87 05 141 U1, the carbons or brushes are guided accurately in a straight line within a shaft, that is to say precisely in the radial direction of the commutator. In this shaft the brushes or carbons are biased against the commutator by means of restoring elements. Straight-line guidance minimises tangential evasion movements of the carbons or brushes which lead to oscillations of said brushes. According to another approach, from which the present invention proceeds, the carbons or brushes are held by leaf springs on their free end, in particular by leaf springs clamped on one side. The leaf springs are biased against the commutator in order to minimise oscillations.

In this regard, it is necessary that the brushes or carbons are seated accurately on the commutator. For this purpose it is known to groove the underside of the brushes or carbons. In operation, the brushes or carbons initially grind themselves in until eventually a concave curvature, which corresponds to the commutator's outer circumference, is formed on their underside. Annoying operating noises, which it is aimed to prevent, arise during grinding in of the brushes or carbons. It is also known from the prior art to grind the underside of the brushes or carbons in a V-shape or with the radius of the commutator. The brushes or carbons are positioned and ground in during operation until eventually a concave curvature, which corresponds to the commutator's outer circumference, is formed on their underside. Attempts are always made to achieve accurate positioning of the brushes by shaping the brush holders appropriately.

### SUMMARY OF THE INVENTION

The object of the invention is to provide a direct current low-power electric motor for motor vehicles in which the brushes can be positioned even more accurately and in which noise development can be reduced still further. In addition, the intention according to the present invention there is to be provided a corresponding electric drive unit.

These and other objects are achieved according to the present invention by an electric motor with the features according to claim 1 and by an electric drive unit with the features according to claim 20. Further advantageous embodiments are the subject matter of the related subclaims.

Thus the invention proceeds from an electric motor comprising a housing and a brush assembly holder, which holds at least two brush holders with brushes attached thereto, such that the brushes are in biased contact with the commutator. In this regard, the brushes are pre-ground to match the commutator, for example V-shaped or with a concave curvature matching the outer circumference of the commutator. According to the invention the electric motor is characterized in that the brush assembly holder is supported movably in relation to the commutator and a limit stop fixed relative to the housing is provided in order to position the brushes accurately on the commutator.

At the same time, it is possible to keep the gap between the brushes and the contact area of the brush assembly holder on the limit stop fixed relative to the housing comparatively small. In addition, it is possible to keep the gap between the limit stop fixed relative to the housing and the motor shaft or the commutator small. Furthermore, the elements referred to above may be precision formed. Other production tolerances, which, for example, are conditional on pushing a plug-in electronic module into the housing of the electric motor, have no effect in this regard on the positioning accuracy of the brushes. Overall, the brushes may thus be positioned more accurately according to the invention.

According to a further embodiment, the brush assembly holder is movably supported in a straight line within a holder, that is, the brush assembly holder may be displaced in a longitudinal direction towards the commutator substantially without twisting, for example, on pushing a plug-in electronic module into the electric motor's housing.

Appropriate mechanical guides, for example telescopic guides, guide rails or guide grooves may be provided for such straight-line guidance. Such mechanical guides may be formed in particular on the inside of the housing facing towards the brush assembly holder and co-operating with said holder. According to a further embodiment, such a straight-line guide is formed by the engagement of pins provided on the brush assembly holder in elongated slots which run parallel to each other and are situated in the holder. In this regard, the profile of the pins may be matched to the cross-section of the elongated slots such that the pins are received in the relevant elongated slot so as to be secured against twisting and/or are received in the elongated slots in such a manner that they are secured against lifting out of said slots.

The limit stop fixed relative to the housing may co-operate with the brush assembly holder, for example with a front edge of said holder, or with the brush holders in order to position the brushes.

According to a further embodiment, it may be possible to alter the location or position of the limit stop in the housing of the electric motor. Consequently, it is possible to compensate for production tolerances and installation errors which result in faulty positioning of the brushes on the commutator. An adjustment means, an adjusting screw for example, which co-operates with the limit stop, may be provided for this purpose in order to alter the location or position of the limit stop within the housing. Such an adjustment means may also be accessible from the outside of the housing with the result that the limit stop's location or position in the housing may be optimised individually for each electric motor during assembly, for example by means of a production robot with optimising function.

To adjust the limit stop, it may be formed as a tongue in the electric motor's housing with an end which is formed in one piece with the housing or is moulded onto said housing, and with a free end the location of which may be altered using the adjustment means, for example by the application of force and bending of the housing tongue. In this case, a gap may be formed between the limit stop and a portion of the housing; the width of said gap may be adjusted using the adjustment means. The adjustment means may be designed such that the gap width is continuously alterable, by tightening an adjusting screw for example. The adjustment means may, according to a further embodiment, also be designed such that the gap width is only alterable in discrete steps, for example by inserting or removing spacer elements into or from the gap. In this way it is also possible to compensate production engineering tolerances and installation errors in particular.

In this regard, the brush assembly holder may be moved beyond the defined operating position on the housing of the electric motor or of a drive unit or of a plug-in element which may be pushed into such a housing, whereby the limit stop fixed relative to the housing restricts the brush assembly holder's movability or adjustment such that the brushes are positioned accurately on the commutator. In order to maintain optimised positioning of the brushes, the brush assembly holder may be biased towards the limit stop by means of a restoring means. In order to maintain optimum positioning of the brushes, the brush assembly holder is thus biased against the limit stop by means of a restoring means, for example by means of restoring springs or flexible conductors. Such a restoring means may itself be electrically conductive in order to connect the electrically conductive brush holders with connection devices, for example connector plugs, of the electric motor so as to be electrically conductive. For this purpose the restoring means may, for example, comprise elastic, electrically conductive lugs or wire structures.

The brush holders may be formed as elastic leaf springs clamped on one side on the brush assembly holder, said springs each holding one brush on their front end in order to bias the brushes radially inwards against the commutator. It is also possible according to the invention to realise other configurations of leaf springs to support the brushes of the electric motor, for example leaf springs bent into a v-shape or the like.

According to a further aspect of the present invention, an electric drive unit for motor vehicles is also provided with an electric motor as described above. Such an electric drive unit may be provided, for example, for electric window lifts, in particular for cable-controlled window lifts, or may be designed as an electric actuator unit for the generation of rotary drive forces.

### OVERVIEW OF FIGURES

The invention will be described in the following in an exemplary manner by reference to the associated drawings from which further features, advantages and objects to be achieved will emerge and wherein:

FIG. 1 shows a drive unit with an electric motor according to the present invention in a perspective view and in partial section;

FIG. 2 shows the configuration of the electric motor and the gearbox according to FIG. 1;

FIG. 3 shows a lateral view of the electric motor according to FIG. 1; and

FIG. 4 shows the electric motor according to FIG. 1 in a greatly enlarged perspective view and in partial section.

Identical reference numbers in the Figures identify elements or groups of elements which are identical or substantially alike.

### DETAILED DESCRIPTION OF PREFERRED EMBODIMENTS

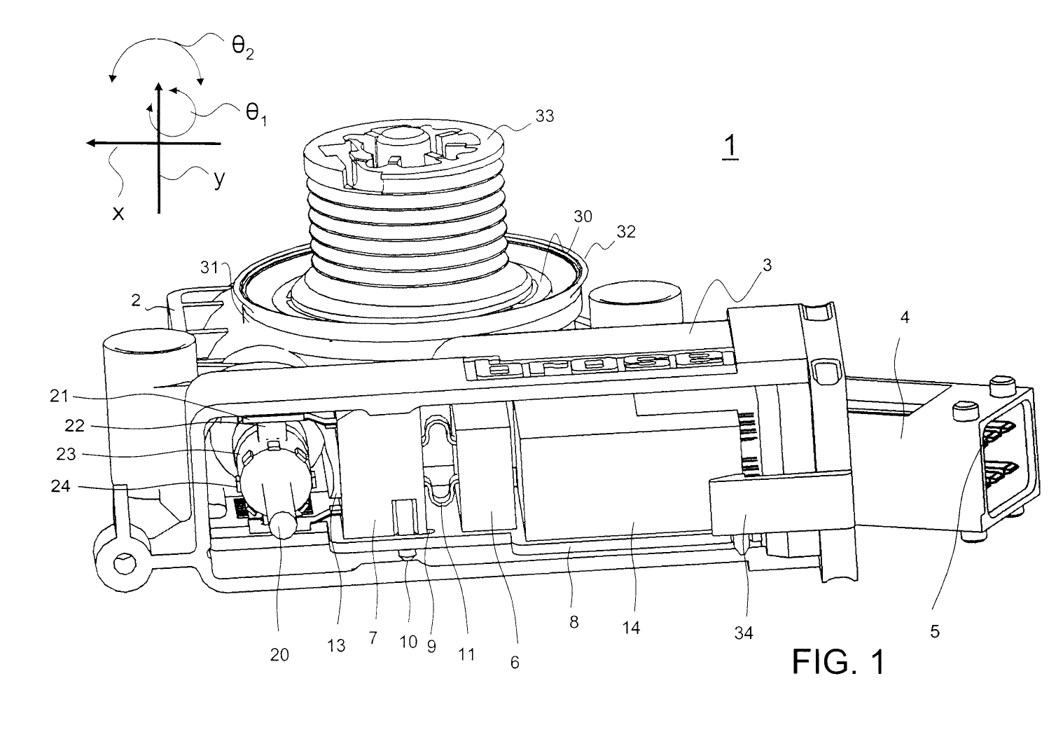

According to FIG. 1, on movable motor shaft 20 sits a rotor core on the outer circumferential surface of which a plurality of commutator bars 23 are periodically disposed at a distance from each other. Connector tongues 24 projecting away from the front face of the rotor core serve to contact the rotor windings. According to FIG. 1, fixed to brush assembly holder 7 are two brush holders 21 shaped as leaf springs, said holders being angled, having one rear end projecting obliquely away from brush assembly holder 7 and having a portion (identified in FIG. 1 by reference number 21), which is situated diametrically opposite to a correspondingly shaped portion, runs parallel to said portion and holds in each case a brush, carbon or graphite element (referred to in the following as brush 22). Brush 22 is rigidly joined in a known manner to the front free end of brush holder 21. According to FIG. 1, both brushes 22 are situated diametrically opposite each other, in contact with commentator bars 23 on the outer circumference of the rotor core. Thus, the brush holders 21 are formed as leaf springs clamped on one side on their rear end, said springs biasing brushes 22 against commutator 23 with a spring force which is directed substantially radially inwards to the rotary centre of motor shaft 20.

During operation of the electric motor, brushes 22 slide on commutator bars 23 and in doing so are excited to oscillations. These oscillations are directed on one hand substantially radially outwards, that is, away from commutator bar 23, and on the other hand, to a lesser extent, also necessarily in the axial direction of motor shaft 20. Such oscillations may lead to the electric motor developing an undesirable noise.

According to FIG. 1, the electric motor sits in a drive unit 1, which in the example shown is configured as the drive unit for an electric cable window lift for motor vehicles although the present invention should not be restricted to this application. According to FIG. 1, electric drive unit 1 comprises a gearbox portion 2 and a motor housing portion 3, in which the electric motor is accommodated. Gearbox portion 2 comprises in the known manner a cylindrical receptacle 31 in which is accommodated a worm wheel 30, the outer toothing of which engages with a worm wheel on the front end of motor shaft 20 extending tangentially to worm wheel 30. On the upper side of worm wheel 30 sits a cable drum 33, which is connected to worm wheel 30 by means of a positive fit. Consequently, a rotary motion of motor shaft 20 is translated into a rotary motion of cable drum 33 around an axis perpendicular to motor shaft 20 in order to wind up or unwind a cable or a Bowden cable.

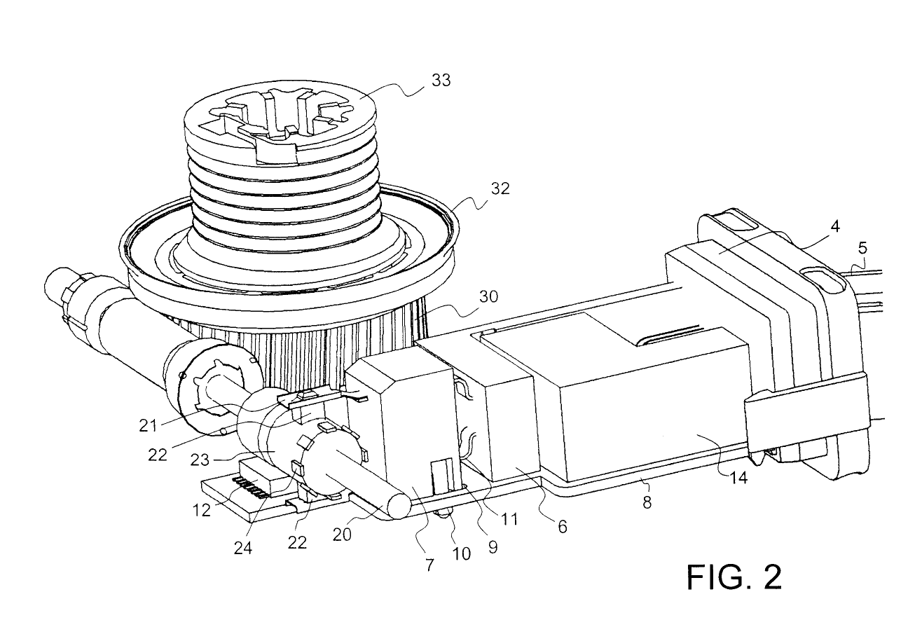

According to FIG. 1, motor housing portion 3 has a substantially rectangular aperture on the side into which a plug-in electronic module 4 may be pushed in from the side. The intention is to describe this plug-in electronic module in greater detail in the following referring to FIG. 2 in which the housing of the drive unit is omitted for reasons of clarity. According to FIG. 2, plug-in electronic module 4 is oblong in shape and on its front end carries both brushes 22 which are in contact with commutator 23 of the electric motor. Plug-in electronic module 4 comprises a panel-shaped mount 8, which may also, for example, be designed as an electric printed circuit board (PCB), on which sit a rear block 14, a front block 6, a brush assembly holder 7 and a component assembly 12. Whilst rear block 14, front block 6 and component assembly 12 sit fixed on panel-shaped mount 8, brush assembly holder 7, as explained in the following, is supported movably in relation to panel-shaped mount 8. Electronic component assembly 12 may comprise an electronic suppressor module and/or a control device for the electric motor and sits immediately adjacent to brushes 22. Blocks 6, 14 shown schematically as rectangular shapes may contain further electronic components, for example for controlling the electric drive unit. All the electronic components of plug-in electronic module 4 are connected so as to be electrically conductive to connector plug 5 on the rear end of plug-in electronic module 4.

Plug-in electronic module 4 is pushed into the lateral aperture of motor housing portion 3 (cf. FIG. 1) until brushes 22 are finally in contact with commutator 23 of the electric motor.

As may be seen in FIG. 1, brushes 22 are pre-ground to match commutator 23, that is to say a concave depression is formed on the underside of brushes 22 facing towards commutator 23, with a radius of curvature which corresponds to the outer radius of commutator 23. Although not shown in the Figures, longitudinal grooves may be formed on the underside of brushes 22 in order to support grinding in of brushes 22 during operation of the motor. Instead of concave dished pre-grinding, it is also possible for V-shaped notches to be formed on the underside of brushes 22 as pre-grinding. For low-noise motor operation it is important that brushes 22 are accurately positioned on commutator 23 so that oscillation or evasion movements of brushes 22 are minimised during motor operation. In addition, the positioning of brushes 22 must be matched to the pre-grinding of brushes 22 in order to ensure that brushes 22 are in contact with commutator 23 over as large an area as possible.

Oblong plug-in electronic module 4, however, represents a comparatively long lever which runs contrary to these requirements since even small tolerances during installation of plug-in electronic module 4 in the housing of drive unit 1 will lead to comparatively large deviations in the position of brushes 22 on commutator 23. In order to minimise these position deviations, according to the invention, brush assembly holder 7 is movably supported on panel-shaped mount 8, and thus forms a virtually independent component in order to compensate tolerances during installation of plug-in electronic module 4.

According to FIG. 2, brushes 22 are rigidly fixed in the known manner on the front end of brush holders 21 formed as leaf springs. Leaf springs 21 are clamped on one side on their rear end in brush assembly holder 7. According to FIG. 2, leaf springs 21 are bent on their rear end so that the front ends bias brushes 22 elastically and in the radial direction against commutator 23. In the operating position according to FIG. 2, both brushes 22 are situated exactly diametrically opposite each other and the two front ends of leaf springs 21 run exactly parallel to each other. Leaf springs 21 are electrically conductive and are connected so as to be electrically conductive to connector plug 5, for example by way of spring elastic conductors 11 shown in FIG. 2 which bias brush assembly holder 7 towards the limit stop.

According to FIG. 2, on the front end of panel-shaped mount 8 are formed elongated slots 9 acting as longitudinal guides, said slots running exactly parallel to each other and into which engage two pins or sliding elements 10 on the underside of brush assembly holder 7 projecting vertically away from said holder and which pins are guided in them so as to slide movably. In this manner brush assembly holder 7 is movably supported on panel-shaped mount 8 in the longitudinal direction of plug-in electronic module 4. In doing so, pins 10 may engage in elongated slot 9 such that brush assembly holder 7 is guided axially in a straight line, thus it may be moved substantially tolerance-free exactly parallel to the lateral edges of mount 8 but it cannot, however, be twisted about an axis standing perpendicular to mount 8. Naturally, such an anti-twist facility may also be provided according to a further embodiment of the invention. In addition, pin 10 may engage in the elongated slot such that vertically, i.e. extending perpendicular to the surface of mount 8, brush assembly holder 7 is supported substantially without play and is thus secured against lifting out of the elongated slot. According to a further embodiment, however, such height compensation may also be provided. In addition, according to a further embodiment, an axial pivot movement of brush assembly holder 7 is possible about an axis standing perpendicular to mount 8. Overall, brush assembly holder 7 thus represents an independent component which may be accurately positioned in relation to commutator 23 or motor shaft 20 regardless of the tolerances during installation of plug-in electronic module 4, as is explained in the following.

According to FIG. 1, elastic conductors 11 are substantially U-shaped and bias brush assembly holder 7 elastically against the front end of elongated slots 9 formed in mount 8. Brush assembly holder 7 and elongated slots 9 are formed in such a manner that, without fixed housing limit stop 13, brushes 22 would be pushed too far onto commutator 23 on pushing plug-in electronic module 4 into drive unit 1 and would thus not be positioned sufficiently accurately. As may be seen in FIG. 1, the gap between brushes 22 and the front edge of brush assembly holder 7 is defined precisely by the geometry of leaf springs 21.

According to the present invention, in the housing of drive unit 1 is provided a limit stop 13 fixed relative to the housing which is positioned such that the gap between the contact surface of limit stop 13 with brush assembly holder 7 and motor shaft 20 is matched precisely to the aforementioned gap between brushes 22 and the front edge of brush assembly holder 7, which is in contact with limit stop 13 in the electric motor's operating position. Without limit stop 13, the front edge of brush assembly holder 7 would, in its resting position, project beyond the contact surface of limit stop 13 when pins 10 are in contact with the front end of elongated slots 9 due to the bias exerted by elastic conductors 11. According to the invention, limit stop 13 fixed relative to the housing enables exact positioning of brushes 22 on commutator 23. Since the gap between limit stop 13 fixed relative to the housing and motor shaft 20 is small by comparison with the overall length of plug-in electronic module 4, according to the invention, brushes 22 may be positioned highly accurately without production or installation tolerances of plug-in electronic module 4 playing any role in this case.

Other restoring elements, for example restoring springs, which elastically bias brush assembly holder 7 towards the front end of mount 8 in relation to front block 6 may also be provided instead of elastic conductors 11. These restoring elements may be used in the same way for electric contacting of leaf springs 21 and brushes 22, or pins 10 may be connected so as to be electrically conductive to leaf springs 21, and electric contact tongues, which are connected so as to be electrically conductive to connector plug 5, may be provided in the region of elongated slots 9.

As shown in FIG. 1, limit stop 13 fixed relative to the housing projects, substantially parallel to motor shaft 20, into the region of motor housing portion 3 into which plug-in electronic module 4 is pushed. In this regard, limit stop 13 fixed relative to the housing may be configured such that it does not project into the path of brushes 22 when plug-in electronic module 4 is pushed into motor housing portion 3. Limit stop 13 may be formed in one piece with drive unit 1, for example by injection moulding out of plastic. Limit stop 13 may also be permanently joined subsequently to the housing of drive unit 1, for example by means of a screwed or glued connection.

As indicated by the inset on the top left of FIG. 1, limit stop 13 restricts the position of brush assembly holder 7 in longitudinal direction x of drive unit 1. Consequently, brush assembly holder 7 is movably supported on mount 8 in longitudinal direction x at least. By way of supplement, according to further embodiments, the following adjustment possibilities may also exist for brush assembly holder 7: height compensation in y-direction and/or perpendicular to mount 8 and/or pivot movement about the y-axis (angle adjustment θ2) and/or twisting about the y-axis (angle adjustment θ1). According to these further embodiments, in this regard limit stop 13 not only determines the position of brush assembly holder 7 in the x-direction but also the height (y-direction) and/or the angle adjustment (angle θ1 and/or angle θ2) in relation to motor shaft 20.

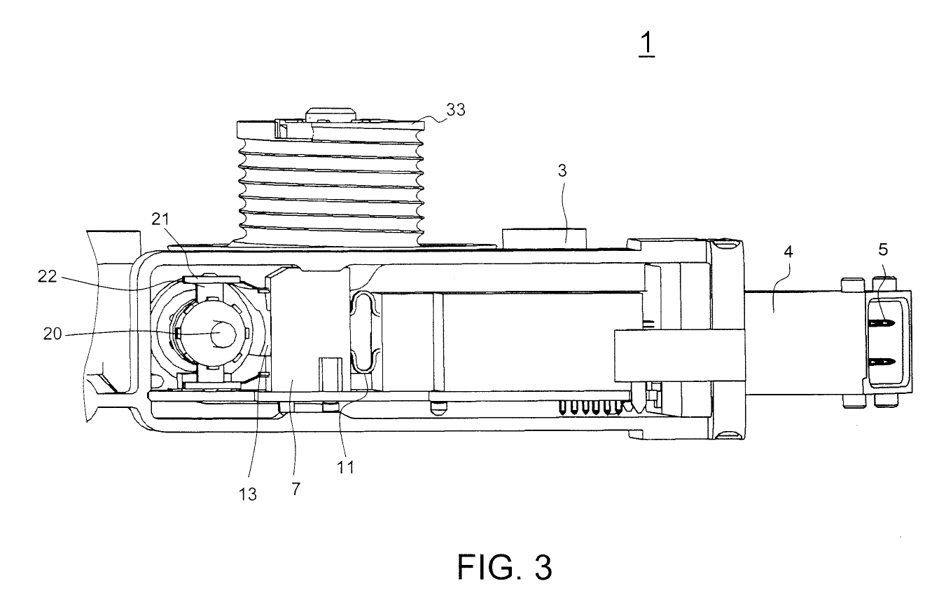

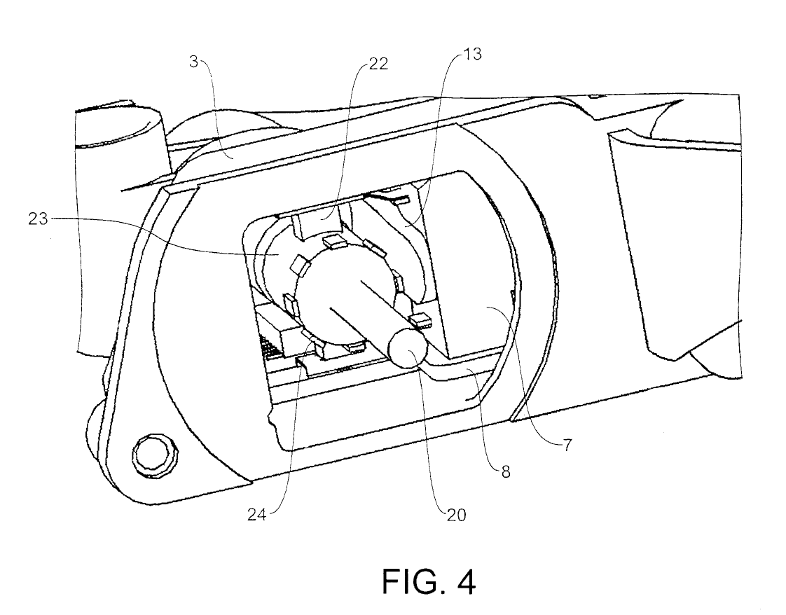

FIG. 3 shows the electric motor according to FIG. 1 in a schematic lateral view. FIG. 4 shows in a greatly enlarged perspective view how the front edge of brush assembly holder 7 is in contact with limit stop 13 fixed relative to the housing in the electric motor's operating position.

According to a further embodiment (not shown), the position or location of the limit stop in the housing may be altered by an adjustment means, for example a screw or a spacer element. In this regard the limit stop may be formed as a tongue joined on one side to the housing or as a tongue formed on said housing whereby a gap is formed between the limit stop and a housing portion situated opposite it, the width of which may be altered using the adjustment means previously mentioned. Production engineering and assembly tolerances may also be compensated in this way.

In order to minimise production tolerances of the housing even further, it is possible according to the invention to form the housing of the drive unit and the limit stop from a common tool, in particular by injection moulding out of a plastic, which is designed such that a demoulding direction for demoulding of bearing supports or points of the electric motor's rotor shaft and limit stop is the same.

The following procedure is followed for installing drive unit 1: first of all the housing is fitted with motor shaft 20, commutator 23 and the field frame (not shown) and plug-in electronic module 4 is created as shown in FIG. 2. Subsequently, plug-in electronic module 4 is pushed into motor housing portion 3 from the side so that brushes 22 are pushed onto commutator 23. On pushing plug-in electronic module 4 in further, the front edge of brush assembly holder 7 finally comes into contact with fixed housing limit stop 13 which determines the electric motor's operating position. Finally, plug-in electronic module 4 is locked in place on motor housing portion 3 using snap or latching element 34 or is joined to it firmly in some other way.

During installation of the drive unit, as described above, it is possible to carry out continuous quality checking in order to determine whether brushes 22 are optimally positioned. Deviations from the optimum position may be compensated during production, by appropriately modifying the position of the brushes on leaf springs 21 for example and/or the fixed support of leaf springs 21 on brush assembly holder 7 and/or the front edge of brush assembly holder 7 and/or the location of fixed housing limit stop 13 and/or the contact surface of limit stop 13 fixed relative to the housing in order to ensure optimum positioning of brushes 22. As will easily be apparent to the person of average skill in the art, the measures referred to above may also be carried out effortlessly during the production process so that, according to the invention, it is possible to manufacture an electric drive unit with low operating noises at low manufacturing costs.

As will easily be apparent to the person of average skill in the art on the basis of FIG. 1, the limit stop referred to above may at the same time be designed to spread and guide brush holder 21 on pushing brushes 22 onto commutator 23. For this purpose, the insides of brush holder 21 may co-operate with lateral surfaces of the limit stop. In this regard, the lateral surfaces of the limit stop may diverge at an acute angle, seen from the direction of pushing in the plug-in electronic module, with the result that, on pushing in said plug-in electronic module, brush holders 21 are gradually forced apart up to the diameter of the commutator. In particular, it is possible by means of the limit stop's lateral surfaces to control the movement of brushes 22 whilst pushing the plug-in electronic module into the housing such that the brushes are moved substantially tangentially towards the commutator with a very small gap to commutator bars 23 and are attached to them substantially radially.

### LIST OF REFERENCE NUMBERS

1 Electric drive unit
2 Gearbox portion
3 Motor housing portion
4 Plug-in electronic module
5 Connector plug
6 Component holder/front block
7 Brush assembly holder
8 Electric printed circuit board/panel-shaped mount
9 Recess/guide
10 Pin/sliding element
11 Flexible conductor
12 Electronic component assembly/chip
13 Limit stop
14 Rear block
20 Motor shaft
21 Brush holder
22 Brush
23 Commutator
24 Rotor tongues
30 Worm wheel
31 Side wall
32 Gasket
33 Cable drum
34 Snap element

1. A direct current low-power electric motor for motor vehicles, comprising:
a housing; and
a brush assembly holder, holding at least two brush holders with brushes attached thereto, such that the brushes are in biased contact with the commutator; wherein:
the brushes are pre-ground corresponding to the commutator;
the brush assembly holder is movably supported in relation to the commutator (23);
a limit stop fixed relative to the housing is provided in order to position the brushes accurately on the commutator; and
a restoring means is provided in order to bias the brush assembly holder towards the limit stop.

2. The electric motor according to claim 1, in which the brush assembly holder is movably supported radially to the commutator such that the brushes are capable of being pushed tangentially onto the commutator.

3. The electric motor according to claim 1, in which the restoring means is supported or formed on the brush assembly holder.

4. The electric motor according to claim 3, in which the restoring means is electrically conductive in order to join the brush assembly holder or the brush holder to a connection means.

5. The electric motor according to claim 4, in which the restoring means comprises at least one elastic and electrically conductive joining means.

6. The electric motor according to claim 1, in which the brush assembly holder is movably supported in a straight line within a mount.

7. The electric motor according to claim 6, in which pins provided on the brush assembly holder engage in elongated slots which are parallel to each other in the mount.

8. The electric motor according to claim 7, in which the pins and/or the elongated slots are formed such that the pins are secured against lifting out of said elongated slots.

9. The electric motor according to claim 6, wherein the housing has a guide for guiding the brush assembly holder.

10. The electric motor according to claim 1, in which the limit stop co-operates with the brush assembly holder in order to position the brushes.

11. The electric motor according to claim 1, in which the brush assembly holder is supported together with an electronic suppressor module on a plug-in element which can be pushed into the housing from the side in order to push the brushes tangentially onto the commutator.

12. The electric motor according to claim 11, in which the brushes are moved along a predetermined path when the plug-in element is pushed into the housing whereby the limit stop is shaped such that it does not project into said predetermined path.

13. The electric motor according to claim 1, in which the brush assembly holder is supported so as to slide movably on electric contact tongues which are joined to connector means so as to be electrically conductive.

14. The electric motor according to claim 1, in which the brush holders are formed as leaf springs clamped on one end, which each hold a brush on their front end, said brush being biased radially inwards against the commutator.

15. The electric motor according to claim 1, in which a surface of the brushes facing towards the commutator is pre-ground in a V-shape or concave curvature corresponding to the profile of the commutator.

16. The electric motor according to claim 1, in which the surface of the brushes facing towards the commutator is further provided with grooves which run tangentially to said commutator.

17. The electric motor according to claim 1, in which the limit stop is formed elastically and the position of the limit stop in the housing is adjustable by way of adjustment means.

18. The electric motor according to claim 1, in which the housing and the limit stop are configured such that a common tool with the same demoulding direction is used for the limit stop and the bearing supports or bearing points for forming said limit stop and bearing supports or bearing points of a rotor shaft of the electric motor by means of injection moulding from a plastic.

19. An electric drive unit for motor vehicles comprising a direct current low-power electric motor, said electric motor comprising:
a housing; and
a brush assembly holder, holding at least two brush holders with brushes attached thereto, such that the brushes are in biased contact with the commutator;
where:
the brushes are pre-ground corresponding to the commutator,
the brush assembly holder is movably supported in relation to the commutator,
a limit stop fixed relative to the housing is provided in order to position the brushes accurately on the commutator, and
a restoring means is provided in order to bias the brush assembly holder towards the limit stop.
